(19) United States
(12) Patent Application Publication
(10) Pub. No.: US 2006/0134297 A1
(43) Pub. Date: Jun. 22, 2006

(54) Pre-mix formulations comprising ingredients for dairy products

(76) Inventor: Craig Bell, Sao Paulo (BR)

Correspondence Address: KNOBBE MARTENS OLSON & BEAR LLP, 2040 MAIN STREET, FOURTEENTH FLOOR, IRVINE, CA, 92614, US

(21) Appl. No.: 10/525,835

(22) PCT Filed: Aug. 26, 2003
(86) PCT No.: PCT/NZ03/00189

§ 371 Date: Sep. 14, 2005

(30) Foreign Application Priority Data
Aug. 26, 2002 (NZ) 520994

(51) Int. Cl. A23C 19/00

(52) U.S. Cl. 426/582

(57) ABSTRACT

Ingredients and methods of using ingredients to produce dairy based food products. The ingredients may include milk protein concentrate, fat containing powders and other compounds including sweetening agents, flavours, preservatives, salts and emulsifiers. Food products that can be made according to the invention include yoghurt, cheese, cheese spreads, sweet spreads, nutrition bars, cream cheese, dairy desserts and sour cream.

### TECHNICAL FIELD

The present invention relates to ingredients useful for making recombined food products.

### BACKGROUND

It is well known in the art that many foodstuffs can be sold in a form suitable for recombination by the consumer. The consumer benefits from the existence of such recombined products in several ways: they do not need to source each individual component of the product separately, and can make the decision as to when to create the final product (for example by mixing the ingredients, or adding water). This delayed creation of the final product ensures that the product is fresh when the consumer needs it.

The demand for such “instant” foods has led to an increase in vendors using “premix” formulations to provide consumers with fresh recombined foods, the foods being mixed and prepared at the point of sale. Such vendors tend to mix the ingredients using low-tech, yet high intensity mixing devices. An example of such a vendor is a mobile ice cream vendor. The machinery is little more than a facilitator for “an add water and mix” process, but the convenience of being able to produce the ice cream at the point of sale avoids problems such as the need for chilled storage space. Also, the consumer knows that the product is fresh, as they have literally seen the product being made in their presence.

Pre-prepared foods used by such vendors generally consist of the dry ingredients of the product, with perhaps some fat or oil added to the ingredient mix. Water is usually added at the time the ingredients are put into the mixing machine. After the ingredients are mixed (and if required heated, cooked or cooled), the product is put into containers for use by the consumer.

There are several known methods of producing food products via the recombining route using a range of milk protein ingredients.

Peters & Knoop (1975) conducted experiments to produce Camembert cheese using mixtures of milk powder and milk. Satisfactory cheese was produced using at least 50% fresh milk.

U.S. Pat. No. 4,066,791 discloses a method for making recombined cheese where an acidified milk powder was produced initially, whereupon reconstitution with water yielded a milk with a pH between 4.95 and 5.3. The acidified milk was clotted with the addition of a proteolytic enzyme and cut and dewheyed using conventional cheese making arts. The resulting curd was suitable for the manufacture of cottage, bakers', cream, and Neufachatel cheese and quark.

Davis (1980) proposed that cheese (including hard, semi-hard and soft cheese styles) could be produced, without producing whey, from dry ingredients and water, using cream (or milk fat), skim milk powder and caseinate and minor ingredients. Flavour production could be accelerated by the addition of small amounts (<1%) of matured Cheddar or Parmesan cheese.

Omar & Buchheim (1983) conducted experiments using instant whole milk powder reconstituted to 20% solids to produce soft brine cheese. Whey was produced upon cutting of the curd and one to two months was required for the cheese to ripen.

Gilles (1984) prepared recombined domiati-type cheese using 52% protein skim milk powder and anhydrous milk fat. The hydrated mixture was fermented with appropriate starter strains, renneted and salted. No whey was produced. After maturation, Gilles concluded that an acceptable cheese could be produced.

Christensen (1988) suggested a dry ingredient based process using calcium caseinate, whey powder and melted fat for the production of cream cheese, labneh, feta, domiati, mozzarella cheeses and dips. The ingredients were combined with water in a high-shear steam-heated mixer. Large-scale, semi-continuous production was envisaged.

Ali & Robinson (1990) experimented with the production of feta-style cheese via the recombining route using anhydrous milk fat, skim milk powder and sodium caseinate. Starter culture was used to reduce the pH and metabolise lactose. Rennet was also used.

After salting and ripening for one month, the experimenters concluded that ‘despite some limitations in respect of functional properties, the manufacture of a Feta-style cheese by direct recombination is clearly feasible’. Ali & Robinson speculated that the advent of high-protein skim milk powders offered further opportunities.

Cawdron in U.S. Pat. No. 4,388,337 teaches the use of a dry powdered mix containing pectin, starch and food acids for reconstitution with milk to produce a dessert with a smooth gel structure.

Ekanyake et al. in U.S. Pat. No. 6,056,984 disclosed another approach to the use of pre-mixes. This patent describes the use of two pre-mixes, each formulated with compatible ingredients. Each pre-mix differs in water activity such that upon combining a range of products including dough, sauces, dressings, batters and beverages can be produced. This approach utilises careful combinations of ingredients, pH and water activity to confer chemical and microbiological stability within each sachet. Upon breaking the seals between the sachets, the mixes are combined to produce the required product formulation. Low intensity mixing without further addition of water is envisaged and the invention does not relate to protein gels such as cheese products. No cooking step is involved.

There are logistical difficulties when scaling down commercial production of a foodstuff (i.e. from large scale production to production of small quantities). This cannot be done by merely reducing the respective quantities of ingredients, as the actual processes involved in making the foodstuff need to be altered substantially to achieve the desired product in a shorter timeframe. The practitioner has to expend considerable time and effort gathering together a range of ingredients, some of which are irregularly used or are used in small quantities, thereby increasing costs and possibly risking ingredient spoilage and wastage. It has also been difficult to create premix formulations which can be used for a wide variety of applications.

It is an object of the present invention to go some way to avoiding the disadvantages described above or at least to provide the public with a useful choice.

### SUMMARY OF INVENTION

In a first aspect the invention provides a dry premix which may be reconstituted with a potable solvent to form a food product, said premix comprising:
a) 5 to 60% w/w milk protein concentrate;
b) 5 to 90% w/w cream powder, powdered vegetable fat, or combinations thereof, and
c) at least one of the following:
   i) 0 to 40% w/w sweetening agent;
   ii) 0 to 25% w/w caseinate or rennet casein;
   iii) 0 to 20% w/w lactose;
   iv) 0 to 20% w/w lactose monohydrate;
   v) 0 to 10% w/w acidulent;
   vi) 0 to 10% w/w whey protein concentrate;
   vii) 0 to 5% w/w whey protein isolate;
   viii) 0 to 5% w/w phosphoric or citric acid salt, or a combination thereof;
   ix) 0 to 5% w/w emulsifier;
   x) 0 to 5% w/w flavouring agent;
   xi) 0 to 5% w/w melting salt;
   xii) 0 to 1% w/w preservative,
   xiii) 0 to 1% w/w hydrocolloid or polysaccharide;
   xiv) 0 to 1% w/w calcium chloride;
   xv) 0 to 15% w/w caseinate; or
   xvi) 0 to 15% w/w vegetable protein;
      wherein % w/w is the percentage dry weight of the ingredient to the total dry weight of all the ingredients.

Preferably ingredients a) to c) are mixed with said potable solvent. In one alternative ingredients a) to c) are mixed together in a dry state before mixing with said potable solvent. In another alternative one or more of ingredients a) to c) are mixed with said potable solvent before being mixed with each other.

Preferably the weight:weight ratio of potable solvent to dry ingredients is between 2.5:1 and 1:2.5

Preferably the method includes a heating step during or after combination of the dry ingredients with the potable solvent. More preferably the potable solvent and ingredients are heated to between about 50 and 90 degrees Celsius. Even more preferably the potable solvent and ingredients are heated to between about 60 and 90 degrees Celsius. Most preferably the potable solvent and ingredients are heated to between about 70 and 90 degrees Celsius.

In a preferred embodiment the method includes a cooling step subsequent to the heating step.

Preferably the potable solvent is water. Alternatively the potable solvent is milk.

Preferably the emulsifier includes a lipid or phospholipid derived agent. A preferred emulsifier for use in the invention is selected from commercial glycerol stearate, a lecithin based formulation, or any combination thereof.

Preferably the flavouring agent is selected from cheese powder, enzyme modified cheese powder, cocoa, coffee, caramel, fruit flavour, savoury flavour, or any combination thereof.

Preferably the preservative is selected from sorbic acid or its salts, propionic acid or its salts, benzoic acid or its salts, nisin, or any combination thereof.

Preferably the hydrocolloid or polysaccharide is selected from alginate, agar, locust bean gum, carageenan, guar, xanthan, pectin, agar, gelatin, modified cellulose or any combination thereof.

Preferably the acidulent is selected from glucono delta lactone (GDL), lactic acid, lactic anhydride, tartaric acid, citric acid, acetic acid or any combination thereof.

In a preferred method according to the invention at least one of the following compounds is added:
i) 3-45% w/w animal fat;
ii) 3-45% w/w vegetable fat, vegetable oil or any combination thereof;
iii) 1-30% w/w liquid sweetening agent;
iv) 0-15% w/w flavouring; or
v) 0-1% w/w coloring;
wherein % w/w is the percentage weight of the compound to the total wet weight of the food product.

Preferably the compound includes anhydrous milk fat.

Preferably the liquid sweetening agent is selected from golden syrup, honey, corn syrup or any combination thereof.

Preferably 0 to 1% salt stabilised chymosin is added, wherein % w/w is the percentage dry weight of the chymosin to the total wet weight of the food product. In a preferred ambodiment the salt stabilised chymosin is added after a heating step.

Preferably 0-10% w/w viable food-grade strain of a bacterial culture is added, wherein % w/w is the percentage dry weight of the strain to the total wet weight of the food produce A preferred strain for use in the invention is grown and stabilised on skim milk powder. A particularly preferred viable food-grade strain of bacterial culture is freeze-dried or spray-dried lactic culture. Preferably the strain is added after an optional heating step.

Preferably the milk protein concentrate has a non-fat component, 40% to 90% of which is milk protein. More preferably 55% and 90%, of the non-fat component of the milk protein concentrate is milk protein.

Most preferably about 56% of the non-fat component of the milk protein concentrate is milk protein Alternatively about 70% of the non-fat component of the milk protein concentrate is milk protein. In another alternative about 85% of the non-fat component of the milk protein concentrate is milk protein.

Preferably the milk protein concentrate forms from about 3% to about 40% by weight of the wet food product.

Preferably the flavouring agent is selected from cheese-like flavour, meat-like flavour, fruit flavour, coffee flavour, caramel flavour, chocolate flavour, savoury flavour or any combination thereof.

Preferably the cream powder comprises about 35% to 85% fat.

Preferably the dry ingredients are in powder form.

In a second aspect the invention provides a dry premix which may be reconstituted with a potable solvent to form a food product said premix comprising:
a) 5 to 60% w/w dried skim milk cheese;
b) 5 to 90% w/w fat cream powder, powdered vegetable fat, or combinations thereof; and
c) at least one of the following:
   i) 0 to 40% w/w sweetening agent;
   ii) 0 to 25% w/w caseinate or rennet casein;
iii) 0 to 20% w/w lactose;
iv) 0 to 20% w/w lactose monohydrate:
v) 0 to 10% w/w acidulent;
vi) 0 to 10% w/w whey protein concentrate;
vii) 0 to 5% w/w whey protein isolate;
viii) 0 to 5% w/w phosphoric or citric acid salt, or a combination thereof;
ix) 0 to 5% w/w emulsifier,
x) 0 to 5% w/w flavouring agent;
xi) 0 to 5% w/w melting salt;
xii) 0 to 1% w/w preservative;
xiii) 0 to 1% w/w hydrocolloid or polysaccharide;
xiv) 0 to 1% w/w calcium chloride;
xv) 0 to 15% w/w caseinate; or
xvi) 0 to 15% w/w vegetable protein;
   wherein % w/w is the percentage dry weight of the ingredient to the total dry weight of all the ingredients.

Preferably ingredients a) to c) are mixed with said potable solvent. In one alternative ingredients a) to c) are mixed together in a dry state before mixing with said potable solvent. In another alternative one or more of ingredients a) to c) are mixed with said potable solvent before being mixed with each other.

Preferably the weight:weight ratio of potable solvent to dry ingredients is between 2.5:1 and 1:2.5.

Preferably the method includes a heating step during or after combination of the dry ingredients with the potable solvent. More preferably the potable solvent and ingredients are heated to between about 50 and 90 degrees Celsius. Even more preferably the potable solvent and ingredients are heated to between about 60 and 90 degrees Celsius. Most preferably the potable solvent and ingredients are heated to between about 70 and 90 degrees Celsius.

In a preferred embodiment the method includes a cooling step subsequent to the heating step.

Preferably the potable solvent is water. Alternatively the potable solvent is milk.

Preferably the emulsifier is selected from glycerol monostearate, lecithin or any combination thereof.

Preferably the flavouring agent is selected from cheese powder, enzyme modified cheese powder, cocoa, fruit flavour, savoury flavour or any combination thereof.

Preferably the preservative is selected from potassium sorbate, sorbic acid or its salts, propionic acid or its salts, benzoic acid or its salts, nisin, or any combination thereof.

Preferably the polysaccharide is selected from alginate, agar, locust bean gum, carageenan, guar, xanthan, pectin, agar, gelatin, modified cellulose or any combination thereof.

Preferably the methods according to the invention her comprise a cutting step.

Preferably the ingredients are combined in a mixing device.

Preferred food products made according to the invention include yoghurt cheese, cheese spread, sweet spread, a nutrition bar, cre=cheese, mousse, petite Suisse, sour cream, or cultured dairy products and their analogs.

In a particularly preferred embodiment the ingredients are kept in separate containers until mixed with other ingredients or the potable solvent. Preferably said containers are bags.

### DETAILED DESCRIPTION

As mentioned herein, references to “recombined” food products refer to the reconstitution of food products from raw or semi-processed ingredients, where such food products are generally sold as a final product, rather then in ingredient form.

It is understood that although the description of the invention contains references to the addition of dry ingredients to other dry ingredients, this does not preclude the possibility that said dry ingredients are kept in the same container from the start.

Preferred preservatives are selected from the list of food approved preservatives given by the United States of America Food and Drug Administration list of approved preservatives with GRAS status, or as local regulations apply. A current list of GRAS approved agents is found at http://vm.cfsan.fda.gov/˜dms/eafus.html.

Skim milk cheese base is prepared from commercial skim milk cheese by grinding, drying to preferably less than 10% moisture and milling to about 30#. Skim milk cheese is a dairy product with a label of identity defined by the United States of America Code of Federal Regulations 21 CFR 133.189.

A “milk protein concentrate” (MPC) and a “milk protein isolate” (MPI) are dried sources of casein and whey protein, or a dried blend of proteins that give milk protein concentrate-like properties of heat coagulation and acid coagulation and enzymatic coagulation.

MPC is a dried milk protein product in which preferably greater than 45% of the non-fat component is milk protein. Such concentrates are known in the art. MPCs are frequently described with the non-fat component % as milk protein being appended to “MPC”. For example MPC70 is an MPC with 70% of the non-fat component as milk protein. In some documents, MPC and MPI are referred to as retentate powder, ultra filtered milk powder and also concentrated milk powder.

MPC and MPI in the context of this invention are considered to be equivalent and further includes the dried product of the ultrafiltration or microfiltration, or combinations of the two, of milk. The performance of MPC or MPI in this invention may be further improved by manipulation of the cation concentrations (specifically the Ca, Mg, Na & K concentrations) by methods known in the art.

MPC and MPI can be further enhanced by the use of whole milk rather than skim milk during ultrafiltration or microfiltration (or combinations of the two) whereupon following drying, a high fat MPC or high fat MPI is obtained. Further enhancements include, but not limited to, blends of milk fat and vegetable oil added during the production of the high fat MPC or MPI. The utility of these high fat MPC and MPI powders is that the rehydration and ease of producing the required fat dispersion (emulsion) is significantly facilitated. A practitioner skilled in the art will recognise that the proportion of fat or oil in the high fat MPC or MPI can be standardised so as to achieve the required fat content of the final product.

For the purposes of this invention, MPC includes all milk powders with a protein content >40% on a fat free basis, and includes the option to prepare said powders using skim milk—buttermilk blends of any proportion. This invention also includes the option of preparing MPC and MPI retentates prior to drying, or upon reconstitution with water, where the proportion of particular casein and whey proteins have been selectively manipulated.

MPI refers to a dried milk protein composition comprising of greater than 85% of the non fat component as milk protein. Such isolates are known in the art.

These products differ from milk concentrates in that they are high in protein and low in lactose. They differ from skim milk concentrates in that they are high in protein and low in lactose.

A known use for MPC and MPI is in cheese manufacture. By addition of these to increase the protein concentration of milk used in the manufacture of cheese, cheese making can be made more consistent and more efficient.

A variety of natural cheese, particularly of the unripened short shelf life type, as well as some other dairy products, are made commercially and domestically on almost a daily basis in small batches. These are usually in the order of a kilogram (domestically or in small catering facilities such as restaurants and canteens), or in batches typically of 10 to 100 kg by manufacturers selling into local street markets, as well as by manufacturers in store-in-store outlets, such as are found widely in supermarkets and shopping malls.

Examples of this product variety include fresh white cheese, yoghurt, drinking yogurt, quark (quarg), lebneh, sour cream, whipping cream and cheese spreads. Large-scale semi continuous or continuous production is typically not a feature of these operations. Producers in this market context are concerned with reliable, fast and consistent small-scale production of a standardised product. Typically such operators produce more than one product on any day and require ease of product switching.

We have discovered that the use of MPC or powdered skim milk cheese, mixed with other ingredients confers significant advantages to the users of such manufacturing systems. Of particular advantage is that the quantity of pre-mix can be tailored to the manufacturers' needs on a ‘one bag per batch’ basis. General formulations are such that product variability is greatly reduced and the tendency to forget to add an ingredient or skimp on high cost components is eliminated. The vendor may use either the whole bag for a batch, or can use a proportion of a bag for lesser volume requirements. There is hence no need to measure proportions of different ingredients when reducing the production size.

Moran et al. teaches that rehydrated MPC and fresh cream is easier to convert to a finely dispersed emulsion than the mixing of rehydrated MPC and anhydrous milk fat, vegetable oil or other sources of fat. Surprisingly, we have found that a mixture of MPC and cream powder also provides ease of emulsion formation similar to fresh cream. These processing attributes, together with their dry powder nature, make them very suitable to be formulated into a pre-mix along with other ingredients.

Water activities of the constituent components may sometimes affect the properties of premixes or ingredient blends, however persons skilled in the art would know how to control these activities using known methods (for example, by the addition of an inert gas to the packaged premix or ingredient blend).

Preferably, the particle size of the pre-mix constituents incorporating the MPC, MPI or their high fat equivalents should be consistent with typical spray dried products. This is found to facilitate rapid and uniform rehydration and minimise particle settling or segregation while the pre-mix is held in storage or in transit. In a preferred embodiment, 99% by weight of the particles of the powder mixture should be <200 μm.

To provide for the ability to produce a range of cheese, cheese-like products and food products, one or more pre-prepared ingredients is used in a particular embodiment of the invention.

Minor ingredients with high functional activity such as, but not limited to, powdered food acids and rennet may be added to the mixture at the appropriate stage of the process but the initial high local concentrations can adversely affect the product (e.g. cause protein precipitation) which increases the mixing time to enable reincorporation or results in a degradation of product quality. A specially formulated pre-mix is used to facilitate the dispersion and incorporation of these agents. The ingredients such as powdered food acids and rennet are diluted with relatively inert agents that include, but are not limited to: salt, lactose, MPC or polysaccharides. Food acids available in powder form may include, but are not limited to, citric acid, salts of hydrogen phosphate, lactic anhydride (also known as lactide), glucono delta lactone (also known as GDL), and tartaric acid.

As mentioned herein, references to “bags” of ingredients refer to prepared packages of selected ingredients or combinations of selected ingredients. It is envisaged that other types of containers of ingredients will be equally applicable in the invention.

The first of the bags containing the ingredients (“Bag 1”) may contain MPC and at least one of the following ingredients in proportions as specified above: MPI, cream powder, cheese powder, sodium caseinate, calcium caseinate, whey protein concentrate, whey protein isolate, solubilised milk protein, a mono-, di- or polysaccharide, a hydrocolloid, an antioxidant, an emulsifying agent, an emulsifying salt, a colouring and/or flavouring agent, vegetable protein powder, a soluble or insoluble oligosaccharide, enzyme modified cheese (EMC) powder or powdered vegetable fat.

The second of the bags containing the ingredients (“Bag 2”) may contain at least one of, but is not limited to, the following ingredients in proportions as noted above: vegetable oil or fat, an antioxidant, an emulsifying ester or glyceride, an oil soluble vitamin, a flavouring agent, or a colouring agent. The form of this pre-mix may be block, chip, granular, powdery or finely particulate.

Another of the bags containing ingredients (“3”) may contain at least one of, but is not limited to, the following ingredients in proportions as noted above: a powdered rennet or a suitable para ic-casein forming or casein micelle destabilising enzyme, salt, powdered food acid, a vitamin, or calcium chloride.

A further bag containing ingredients (“Bag 4”) may contain at least one of, but is not limited to, the following powdered ingredients in proportions noted above: MPC, milk powder, a viable food approved strain of a microorganism or enzyme, or stabilisers.

Another bag containing ingredients (“Bag 5”) may contain at least one of, but is not limited to, the following ingredients in proportions as noted above: fruit pulp, vegetable pulp, a plant extract, a herb, nuts, a spice, honey, golden syrup or corn syrup.

Another of the bags containing ingredients (“Bag 6”) may contain either a liquid rennet or an enzyme.

Another of the bags containing ingredients (“Bag 7”) may contain at least one of, but is not limited to, the following liquid ingredients in proportions noted above: a savoury extract, a fermentation concentrate, or a flavour concentrate.

Yet another of the bags containing the ingredients (“Bag 8”) may contain at least one of, but is not limited to, the following ingredients in proportions noted above: animal tissue, an animal tissue extract, a preservative or a smoke flavour.

It is envisaged that the bags of ingredients may be composed of constituents that are in themselves blends or combinations of ingredients.

The number of bags of ingredients required for the manufacture of a particular food product may be as many as eight. However, the usual number would be from two to four bags of ingredients.

To produce a food product, all or a proportion of the dry ingredients together with the required amount of water or milk (at ambient temperature or heated) are placed in a mixer.

Suitable mixers are known in the art, and are similar to those manufactured by Stephans™ and Hobart™. Such mixers include a vessel where mixing takes place and an agitator. The vessel wall comprises a jacket through which hot or cold liquid may be circulated in order to adjust the temperature of the mixture as required. An alternative method of heating mixtures in the vessel is by the application of culinary steam directly to the mixture. The addition of culinary steam is ideal when a mixture needs to be heated in a shorter time.

Mixing is commenced and continued until the proteins are fully dispersed. Heat is applied indirectly through the wall of the vessel and/or directly, such as via the admission of culinary steam. Any desired temperature up to the boiling point of the mixture may be attained but about 72° C. is preferred. The optimum heating/cooking temperature is held to attain the required protein restructuring, emulsification or pasteurisation conditions, whichever is the longer. If no further ingredients are to be added, the product may be poured into vessels for sale or consumption. Cooling may be facilitated prior to pouring by circulating cool water in the jacket of the mixing vessel. Cooling may be completed after packing by holding the product initially at ambient and then completed in a chilled room or chamber.

It is also envisaged that some of the dry ingredients can be added to the mixer without the addition of water. Heat is applied via the jacket of the vessel and mixing commences. Once the melted fat or oil has coated the non-fat constituents, (formed a roux-like emulsion) water or milk may be added and processing continues to the cooking and pasteurisation stages.

The hot molten mass is cooled by circulating cool water through the water jacket of the vessel. Once the mass attains a temperature of between about 25° and 40° C., all or part of the remaining ingredients may be added as necessary. Further mixing continues to fully incorporate these ingredients.

The product is then poured into vessels of the processor's choice. Preferably the packed product is placed in chilled storage to cool further, and set-up prior to sale, dispatch or consumption.

For the production of specific food products, Bags 3 or 4 as described above may be added prior to the heating stage.

For the production of other specific food products, any of Bags 5 to 8 as described above may be added prior to the cooking or pasteurisation stages.

The requisite set of bags can be consolidated into a unit package to provide all the necessary constituents, apart from water, for the preparation of a defined quantity of a specified product. An array of products can be offered via a selection of unit packs for the convenience of the manufacturer or consumer who thereby has the ability to readily select or change products with minimal fuss.

This invention gives manufacturers of recombined natural cheese and cheese-type products and recombined food products an efficient and reliable process for their production. In addition, little know-how is required to produce the final products from the specified ingredients in the present invention. The technology utilized in the method requires little more than a mixer as described above.

A further advantage is that there is little or no waste stream from the method. The resulting products have similar consistencies, textures and tastes of similar pre-prepared products bought from “off the shelf”.

### EXAMPLES

The following are examples of food products that are able to be made in accordance with the present invention. These formulations were found to have similar consistencies, textures and tastes to similar products bought preprepared “off the shelf”. The examples are directed to 1 kilogram batches of food product. It is understood that a person skilled in the art could easily create differing batch volumes based on the information provided in the examples.

### Example 1

| Yoghurt | Ingredients | Quantity (gm) |
|---|---|---|
| Bag 1 | MPC (42% protein) | 80 |
| | Cream powder (70% fat) | 51 |
| | Sucrose | 55 |
| | Emulsifying agent | 4.5 |
| | K sorbate | 2 |
| Bag 2 | GDL | 17.8 |
| Water | | 789.7 |
| Total | | 1000 |

Bag 1 was combined with water in a mixer comprising a vessel and an agitator, with the vessel wall having a jacket through which hot or cold liquid was able to be circulated in order to adjust the temperature of the mixture as required.

Mixing was commenced, and heat was applied to the mixture through the wall of the vessel. The mixture was heated to about 75 degrees Celsius for 3 minutes. The mixture was then cooled to 50 degrees Celsius, whereupon Bag 2 was added and mixed in. The mixture was then poured into containers.

The resulting product had the taste and texture of a yoghurt.

### Example 2

| Cheese type 1 | Ingredients | Quantity (gm) |
|---|---|---|
| Bag 1 | MPC (70% protein) | 230.5 |
| | Powdered vegetable fat | 195 |
| | (hydrogenated) | |
| | Carageenan | 1 |
| Bag 2 | NaCl | 11.5 |
| | CaCl₂.2H₂O | 0.16 |
| | K sorbate | 1.0 |
| Bag 3 | GDL | 4.6 |
| | Rennet powder | 0.08 |
| Water | | 556.16 |
| Total | | 1000 |

Bags 1 and 2 were combined with water in a mixer as described above, and heating and cooling was performed as in Example 1. Once cooled, Bag 3 was added to the mixture and the mixture was then poured into containers.

The resulting product had the texture and flavour of a cheese.

### Example 3

| Cheese type 2 | Ingredients | Quantity (gm) |
|---|---|---|
| Bag 1 | MPC (85% protein) | 284.4 |
| | Cream powder (70% fat) | 290.8 |
| | Enzyme modified cheese powder | 24.5 |
| Bag 2 | NaCl | 13.1 |
| | Lactic acid anhydride | 11.4 |
| | Na₂HPO₄.2H₂O | 16.3 |
| Water | | 359.5 |
| Total | | 1000 |

Bags 1 and 2 were combined with water in a mixer as described above. Mixing commenced, and mixture was heated to about 75 degrees Celsius for about 3 minutes. The mixture was then poured into containers for storage.

The product had the flavour and texture of a hard cheese.

### Example 4

| Cheese type 3 | Ingredients | Quantity (gm) |
|---|---|---|
| Bag 1 | Skim milk cheese powder | 222.4 |
| | (10% moisture) | |
| | Cream powder (70% fat) | 222.4 |
| | Whey protein concentrate | 33.5 |
| Bag 2 | Na₃ citrate | 19.6 |
| | NaCl | 7.8 |
| Water | | 491.9 |
| Total | | 1000 |

The Bags and water were mixed, heated and poured as in Example 3, with the resulting product having the texture an flavour of a stretchable cheese.

### Example 5

| Cheese spread 1 | Ingredients | Quantity (gm) |
|---|---|---|
| Bag 1 | MPC (70% protein) | 107 |
| | Cream powder (70% fat) | 204 |
| | Lactose monohydrate | 64 |
| | Carageenan | 0.9 |
| Bag 2 | Citric acid | 8.5 |
| | Na₂HPO₄.2H₂O | 6 |
| | K sorbate | 1 |
| | Salt | 8 |
| | Enzyme modified cheese | 10 |
| Water | | 590.6 |
| Total | | 1000 |

The Bags and water were mixed, heated and poured as in Example 3, with the product having the flavour and texture of a cheese spread.

### Example 6

| Cheese spread 2 | Ingredients | Quantity (gm) |
|---|---|---|
| Bag 1 | MPC (70% protein) | 109 |
| | Cream powder (70% fat) | 350 |
| | Enzyme modified cheese powder 1 | 5 |
| | Enzyme modified cheese powder 2 | 26.6 |
| | NaCl | 9.9 |
| | Melting salts | 9.9 |
| Water | | 489.6 |
| Total | | 1000 |

The Bag was mixed with water and heated and poured as in Example 3, with the product having the flavour and texture of a cheese spread.

### Example 7

| Nutrition bar | Ingredients | Quantity (gm) |
|---|---|---|
| Bag 1 | MPC (85% protein) | 53 |
| | Rennet casein | 140 |
| | Cream powder (70% fat) | 165 |
| | Whey protein isolate | 30 |
| Bag 2 | NaHPO₄.2H₂O | 17 |
| | Surcrose | 15 |
| | Citric acid | 6.8 |
| | Cocoa powder | 29 |
| | Chocolate flavour | 3.5 |
| Bag 3 | Golden syrup | 180 |
| | Honey | 15 |
| Water | | 345.7 |
| Total | | 1000 |

The Bags were mixed with water in a mixer as described above. Mixing commenced and the mixture was heated to 85 degrees Celsius for 5 minutes. The mixture was then poured into containers. The product was had the flavour and texture of a nutrition bar.

### Example 8

| Cream cheese | Ingredients | Quantity (gm) |
|---|---|---|
| Bag 1 | MPC (85% protein) | 31.2 |
| | Cream powder (70% fat) | 421.9 |
| | Locust bean gum | 2 |
| | Carageenan | 0.5 |
| Bag 2 | Na₂HPO₄.2H₂O | 5 |
| | Salt | 8.1 |
| Bag 3 | GDL | 18.8 |
| Water | | 512.5 |
| Total | | 1000 |

The Bags were mixed and heated as in Example 2, with the product having the texture and flavour of a cream cheese.

### Example 9

| Dairy dessert 1 | Ingredients | Quantity (gm) |
|---|---|---|
| Bag 1 | MPC (85% protein) | 48 |
| | Cream powder (70% fat) | 310.4 |
| | Sucrose | 43.6 |
| | Locust bean gum | 3.8 |
| Bag 2 | Na₂HPO₄.2H₂O | 5.1 |
| | Citric acid | 7.6 |
| Water | | 581.5 |
| Total | | 1000 |

The Bags were mixed as in Example 3, with the product having the texture and flavour of a mousse-like dessert.

### Example 10

| Dairy dessert 2 | Ingredients | Quantity (gm) |
|---|---|---|
| Bag 1 | MPC (56% protein) | 71.9 |
| | WPC (80% protein) | 16 |
| | Cream powder (70% fat) | 81.9 |
| | Sucrose | 99.8 |
| | Carageenan | 0.2 |
| Bag 2 | GDL | 18 |
| Water | | 712.2 |
| Total | | 1000 |

The Bags were mixed and heated as in Example 1, with the product having the texture and flavour of a cheese-like dessert.

### Example 11

| Sweet spread | Ingredients | Quantity (gm) |
|---|---|---|
| Bag 1 | MPC (70% protein) | 107 |
| | Cream powder (70% fat) | 204 |
| | Sucrose | 64 |
| | Carageenan | 0.9 |
| Bag 2 | Citric acid | 8.5 |
| | Na2HPO4.2H2O | 6 |
| | K sorbate | 1 |
| | Strawberry flavour | 1 |
| | Salt | 2.5 |
| Water | | 605.1 |
| Total | | 1000 |

The Bags were mixed and heated as in Example 3, with the product having the texture and flavour of a sweet spread.

### REFERENCES

Christensen P. (1988) Recombined cheese. North European food and dairy journal. 3, 99-105.
Davis, J. G. (1980) Cheesemaking without liquid milk. Dairy Industries International, 45, 7-15.
Gilles J. (1984) The manufacture of white cheese using high total solids recombined milk. New Zealand Journal of Dairy Science and Technology. 19, 1, 3742.
Omar, M. M. & Buchheim W. (1983) Composition and microstructure of soft brine cheese made from instant whole milk powder. Food Microstructure, 2, 43-50.
Peters, K. H. & Knoop, A. M. (1975) The manufacture of Camembert from mixtures of dry and fresh milks. Michwissenschaft 30, 205-209.

1. A dry premix which may be reconstituted with a potable solvent to form a food product, said premix comprising:
a) 5 to 60% w/w milk protein concentrate;
b) 5 to 90% w/w cream powder, powdered vegetable fat, or combinations thereof; and
c) at least one of the following:
i) 0 to 40% w/w sweetening agent;
ii) 0 to 25% w/w caseinate or rennet casein;
iii) 0 to 20% w/w lactose;
iv) 0 to 20% w/w lactose monohydrate;
v) 0 to 10% w/w acidulent;
vi) 0 to 10% w/w whey protein concentrate;
vii) 0 to 5% w/w whey protein isolate;
viii) 0 to 5% w/w phosphoric or citric acid salt, or a combination thereof;
ix) 0 to 5% w/w emulsifier;
x) 0 to 5% w/w flavouring agent;
xi) 0 to 5% w/w melting salt;
xii) 0 to 1% w/w preservative;
xiii) 0 to 1% w/w hydrocolloid or polysaccharide;
xiv) 0 to 15% w/w caseinate; or
xvi) 0 to 15% w/w vegetable protein;
wherein % w/w is the percentage dry weight of the ingredient to the total dray weight of all the ingredients.

2. A method for producing a food product wherein ingredients a) to c) defined in claim 1 are mixed with said potable solvent.

3. A method according to claim 2 wherein ingredients a) to c) are mixed together in a dry state before mixing with said potable solvent.

4. A method according to claim 2 wherein one or more of ingredients a) to c) are mixed with said potable solvent before being mixed with each other.

5. A method according to claim 2 wherein the weight:weight ratio of potable solvent to dry ingredients is between 2.5:1 and 1:2.5.

6. A method according to claim 2 wherein the method includes a heating step during or after combination of the dry ingredients with the potable solvent.

7. A method according to claim 6 wherein the potable solvent and ingredients are heated to between about 50 and 90 degrees Celsius.

8. (canceled)

9. (canceled)

10. A method according to claim 6 wherein the method includes a cooling step subsequent to the heating step.

11. A method according to claim 2 wherein the potable solvent is water or milk.

12. (canceled)

13. A method according to claim 2 wherein the emulsifier includes a lipid or phospholipid derived agent.

14. A method according to claim 13 wherein the emulsifier is selected from commercial glycerol stearate, a lecithin based formulation, or any combinations thereof.

15. A method according to claim 2 wherein the flavouring agent is selected from cheese powder, enzyme modified cheese powder, cocoa, coffee, caramel, fruit flavour, savoury flavour, or any combination thereof.

16. A method according to claim 2 wherein the preservative is selected from sorbic acid or its salts, propionic acid or its salts, benzoic acid or its salts, nisin, or any combination thereof.

17. A method according to claim 2 wherein the hydrocolloid or polysaccharide is selected from alginate, agar, locust bean gum, carageenan, guar, xanthan, pectin, agar, gelatin, modified cellulose or any combination thereof.

18. A method according to claim 2 wherein the acidulent is selected from the glucono delta lactone (GDL), lactic acid, lactic anhydride, tartaric acid, citric acid, acetic acid or any combination thereof.

19. A method according to claim 2 wherein at least one of the following compounds is added:
i) 3-45% w/w animal fat;
ii) 3-45% w/w vegetable fat, vegetable oil or any combination thereof;
iii) 1-30% w/w liquid sweetening agent;
iv) 0-15% w/w flavouring; or
v) 0-1% w/w colouring;
wherein % w/w is the percentage weight of the compound to the total wet weight of the food product.

20. A method according to claim 19 wherein the compound includes anhydrous milk fat.

21. A method according to claim 19 wherein the liquid sweetening agent is selected from golden syrup, honey, corn syrup or any combination thereof.

22. A method according to claim 2, wherein 0 to 1% w/w salt stabilized chymosin is added, wherein % w/w is the percentage dry weight of the chymosin to the total wet weight of the food product.

23. (canceled)

24. A method according to claim 2 wherein 0-10% w/w viable food-grade strain of a bacterial culture is added, wherein % w/w is the percentage dry weight of the strain to the total wet weight of the food product.

25. (canceled)

26. A method according to claim 24 wherein said viable food-grade strain of bacterial culture is freeze-dried or spray-dried lactic culture.

27. A method according to claim 6 wherein a viable food-grade strain of bacterial culture is added after the heating step.

28. A method according to claim 2 wherein the milk protein concentrate has a non-fat component, 40% to 90% of which is milk protein.

29. A method according to claim 28 wherein between 55% and 90% of the non-fat component of the milk protein concentrate is milk protein.

30. (canceled)

31. (canceled)

32. (canceled)

33. A method according to claim 2 wherein the milk protein concentrate forms from about 3% to about 40% by weight of the wet food product.

34. (canceled)

35. A method according to claim 2 wherein ingredient b) is cream powder, said cream powder comprising about 35% to 85% fat.

36. A method according to claim 2 wherein the dry ingredients are in powder form.

37. A dry premix which may be reconstituted with a potable solvent to form a food product, said premix comprising:
a) 5 to 60% w/w dried skim milk cheese;
b) 5 to 90% w/w cream powder, powdered vegetable fat, or combinations thereof; and
c) at least one of the following:
i) 0 to 40% w/w sweetening agent;
ii) 0 to 25% w/w caseinate or rennet casein;
iii) 0 to 20% w/w lactose;
iv) 0 to 20% w/w lactose monohydrate;
v) 0 to 10% w/w acidulent;
vi) 0 to 10% w/w whey protein concentrate;
vii) 0 to 5% w/w whey protein isolate;
viii) 0 to 5% w/w phosphoric or citric acid salt, or a combination thereof;
ix) 0 to 5% w/w emulsifier;
x) 0 to 5% w/w flavouring agent;
xi) 0 to 5% w/w melting salt;
xii) 0 to 1% w/w preservative;
xiii) 0 to 1% w/w hydrocolloid or polysaccharide;
xiv) 0 to 1% w/w calcium chloride;
xv) 0 to 15% w/w caseinate; or
xvi) 0 to 15% w/w vegetable protein;
wherein % w/w is the percentage dry weight of the ingredient to the total dry weight of all the ingredients.

38. A method for producing a food product wherein ingredients a) to c) defined in claim 37 are mixed with said potable solvent.

39. A method according to claim 37 wherein ingredients a) to c) are mixed together in a dry state before mixing with said potable solvent.

40. A method according to claim 37 wherein one or more ingredients a) to c) are mixed with said potable solvent before being mixed with each other.

41. A method according to claim 37 wherein the weight:weight ratio of potable solvent to dry ingredients is between 2.5:1 and 1:2.5.

42. A method according to claim 37 wherein the method includes a heating step during or after combination of the dry ingredients with the potable solvent.

43. A method according to claim 42 wherein the potable solvent and ingredients are heated to between about 50 and 90 degrees Celsius.

44. (canceled)

45. (canceled)

46. A method according to claim 42 wherein the method includes a cooling step subsequent to the heating step.

47. A method according to claim 37 wherein the potable solvent is water or milk.

48. (canceled)

49. A method according to claim 37 wherein the emulsifier is selected from glycerol monostearate, lecithin or any combination thereof.

50. (canceled)

51. A method according to claim 37 wherein the preservative is selected from potassium sorbate, sorbic acid or its salts, propionic acid or its salts, benzoic acid or its salts, nisin, or any combination thereof.

52. A method according to claim 37 wherein the polysaccharide is selected from alginate, agar, locust bean gum, carageenan, guar, xanthan, pectin, agar, gelatin, modified cellulose or any combination thereof.

53. (canceled)

54. (canceled)

55. (canceled)

56. (canceled)

57. (canceled)

58. (canceled)
